(19) United States
(12) Patent Application Publication
(10) Pub. No.: US 2020/0355507 A1
(43) Pub. Date: Nov. 12, 2020

(54) INFORMATION PROCESSING DEVICE, INFORMATION PROCESSING METHOD, AND MOBILE-SHOP VEHICLE

(71) Applicant: TOYOTA JIDOSHA KABUSHIKI KAISHA, Toyota-shi (JP)

(72) Inventors: Masaki SHITARA, Nagakute-shi (JP); Hiromichi DOGISHI, Nagoya-shi (JP); Keiji YAMASHITA, Nisshin-shi (JP); Nozomi KANEKO, Nagoya-shi (JP); Naoki YAMAMURO, Nagoya-shi (JP); Shunsuke TANIMORI, Susono-shi (JP); Ryoichi SHIRAISHI, Anjo-shi (JP)

(73) Assignee: TOYOTA JIDOSHA KABUSHIKI KAISHA, Toyota-shi (JP)

(21) Appl. No.: 15/929,268

(22) Filed: Apr. 21, 2020

(30) Foreign Application Priority Data
May 7, 2019 (JP) 2019-087598

(51) Int. Cl. G01C 21/34; G06Q 50/30; G06Q 10/08; G06Q 30/02; G06Q 10/04; G05D 1/00; G05D 1/02

(52) U.S. Cl. CPC G01C 21/3407; G06Q 50/30; G06Q 10/087; G05D 2201/0213; G06Q 10/047; G05D 1/0088; G05D 1/0212; G06Q 30/0205

(57) ABSTRACT

An information processing device includes a control unit configured to perform: determining a replenishment commodity which is a commodity with which a mobile-shop vehicle is to be replenished based on sales conditions of a plurality of types of commodities when the commodities are sold by the mobile-shop vehicle in a predetermined sales territory; and creating a traveling plan for the mobile-shop vehicle based on information on a purchase location in which the replenishment commodity is to be purchased.

### INCORPORATION BY REFERENCE

The disclosure of Japanese Patent Application No. 2019-087598 filed on May 7, 2019 including the specification, drawings and abstract is incorporated herein by reference in its entirety.

### BACKGROUND

### 1. Technical Field

The disclosure relates to an information processing device and an information processing method that manage traveling of a mobile-shop vehicle which can travel autonomously, and a mobile-shop vehicle.

### 2. Description of Related Art

Japanese Patent Application Publication No. 2018-124676 (JP 2018-124676 A) discloses a technique associated with a method of delivering luggage using an automated-driving vehicle. In the technique described in JP 2018-124676 A, a management device determines a delivery destination area based on delivery destination information of luggage. The management device also determines whether parking and stopping of a vehicle are prohibited in the delivery destination area. The management device generates notification information indicating whether delivery of luggage by the automated-driving vehicle to a delivery destination indicated by the delivery destination information is possible based on a result of determination, and transmits the notification information to a client terminal.

### SUMMARY

The disclosure provides a technique capable of promoting sales of commodities meeting users' needs in a sales territory in which commodities are sold when commodities are sold to users using a mobile-shop vehicle which can travel autonomously.

According to a first aspect of the disclosure, there is provided an information processing device that manages traveling of a mobile-shop vehicle which sells commodities to users and which is able to travel autonomously. The information processing device includes a control unit configured to perform: determining a replenishment commodity which is a commodity with which the mobile-shop vehicle is to be replenished based on sales conditions of a plurality of types of commodities when the commodities are sold by the mobile-shop vehicle in a predetermined sales territory; and creating a traveling plan for the mobile-shop vehicle based on purchase location information on a purchase location in which the replenishment commodity is to be purchased and which includes at least position information of the purchase location.

According to a second aspect of the disclosure, there is provided a mobile-shop vehicle that sells commodities to users and that is able to travel autonomously. The mobile-shop vehicle includes an information processing device configured to perform: determining a replenishment commodity which is a commodity with which the mobile-shop vehicle is to be replenished based on sales conditions of a plurality of types of commodities when the commodities are sold by the mobile-shop vehicle in a predetermined sales territory; and creating a traveling plan for the mobile-shop vehicle based on purchase location information on a purchase location in which the replenishment commodity is to be purchased and which includes at least position information of the purchase location.

According to a third aspect of the disclosure, there is provided an information processing method of managing traveling of a mobile-shop vehicle which sells commodities to users and which is able to travel autonomously, the information processing method being performed by a computer. The information processing method includes: determining a replenishment commodity which is a commodity with which the mobile-shop vehicle is to be replenished based on sales conditions of a plurality of types of commodities when the commodities are sold by the mobile-shop vehicle in a predetermined sales territory; and creating a traveling plan for the mobile-shop vehicle based on purchase location information on a purchase location in which the replenishment commodity is to be purchased and which includes at least position information of the purchase location.

According to a fourth aspect of the disclosure, there is provided a program causing a computer to perform an information processing method of managing traveling of a mobile-shop vehicle which sells commodities to users and which is able to travel autonomously. The information processing method includes: determining a replenishment commodity which is a commodity with which the mobile-shop vehicle is to be replenished based on sales conditions of a plurality of types of commodities when the commodities are sold by the mobile-shop vehicle in a predetermined sales territory; and creating a traveling plan for the mobile-shop vehicle based on purchase location information on a purchase location in which the replenishment commodity is to be purchased and which includes at least position information of the purchase location.

According to the disclosure, it is possible to promote sales of commodities meeting users' needs in a sales territory in which commodities are sold when commodities are sold to users using a mobile-shop vehicle which can travel autonomously.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a diagram schematically illustrating a configuration of a vehicle management system according to an embodiment;

FIG. 2 is a block diagram schematically illustrating an example of functional configurations of a vehicle and a vehicle management server constituting the vehicle management system according to the embodiment;

FIG. 3 is a diagram illustrating an example of a configuration of a sales information table which is stored in a sales information database;

FIG. 4 is a diagram illustrating an example of a configuration of a factory information table which is stored in a factory information database;

FIG. 5 is a flowchart illustrating a flow of a replenishment commodity determining process and a traveling plan creating process according to the embodiment; and

FIG. 6 is a flowchart illustrating a flow of a replenishment commodity determining process and a traveling plan creating process according to a modified example.

### DETAILED DESCRIPTION OF EMBODIMENTS

A mobile-shop vehicle which is managed by an information processing device according to the disclosure is a vehicle that can travel autonomously. Accordingly, a mobile-shop vehicle can move to a predetermined sales territory by autonomous traveling and sell commodities to users in the predetermined sales territory. A mobile-shop vehicle performs autonomous traveling based on a traveling plan which is created by a control unit of the information processing device.

When commodities are sold using a mobile-shop vehicle, regional characteristics, users' tastes, or the like vary depending on a sales territory which is a destination and thus users' needs may vary depending on the sales territory. Accordingly, sales conditions of commodities in the mobile-shop vehicle may vary depending on the sales territory. That is, more commodities for which users' needs in the sales territory are higher may be sold. Accordingly, by maintaining an inventory of commodities for which users' needs in the sales territory are higher in the mobile-shop vehicle, it is possible to promote sales of commodities meeting users' needs.

Therefore, in the information processing device according to the disclosure, a control unit determines a replenishment commodity which is a commodity with which the mobile-shop vehicle is to be replenished based on sales conditions of a plurality of types of commodities when the commodities are sold by the mobile-shop vehicle in a predetermined sales territory. At this time, the control unit determines a commodity for which users' needs in the predetermined sales territory can be determined to be high as the replenishment commodity.

The control unit creates a traveling plan for the mobile-shop vehicle based on purchase location information on a purchase location in which the replenishment commodity is to be purchased. Here, the purchase location is a facility or the like corresponding to a type of the replenishment commodity. For example, a store that wholesales the replenishment commodity or a production site (such as a factory or a farm) of the replenishment commodity can be the purchase location. The purchase location information includes position information of the purchase location.

Facilities or the like which may serve as candidates of the purchase location may be identified based on the commodities which are sold in the mobile-shop vehicle, and information on the facilities may be acquired and stored as a database in the information processing device. In this case, when the replenishment commodity is determined, purchase location information on the purchase location of the replenishment commodity can be acquired from the database. After the replenishment commodity has been determined, purchase location information on the purchase location of the replenishment commodity may be acquired from an external device via a network.

By causing the mobile-shop vehicle to travel based on the traveling plan which has been created in this way, it is possible to replenish the mobile-shop vehicle with the replenishment commodity. That is, according to the disclosure, it is possible to replenish the mobile-shop vehicle with commodities for which users' needs in a predetermined sales territory are high by movement of the mobile-shop vehicle. As a result, it is possible to sell the replenished commodities for which users' needs are high in the predetermined sales territory using the mobile-shop vehicle. Accordingly, it is possible to promote sales of commodities meeting users' needs in the predetermined sales territory.

Hereinafter, a specific embodiment of the disclosure will be described with reference to the accompanying drawings. Sizes, materials, shapes, relative arrangements thereof, and the like of constituent elements described in the embodiment are not intended to limit the technical scope of the disclosure unless otherwise described.

### Embodiment

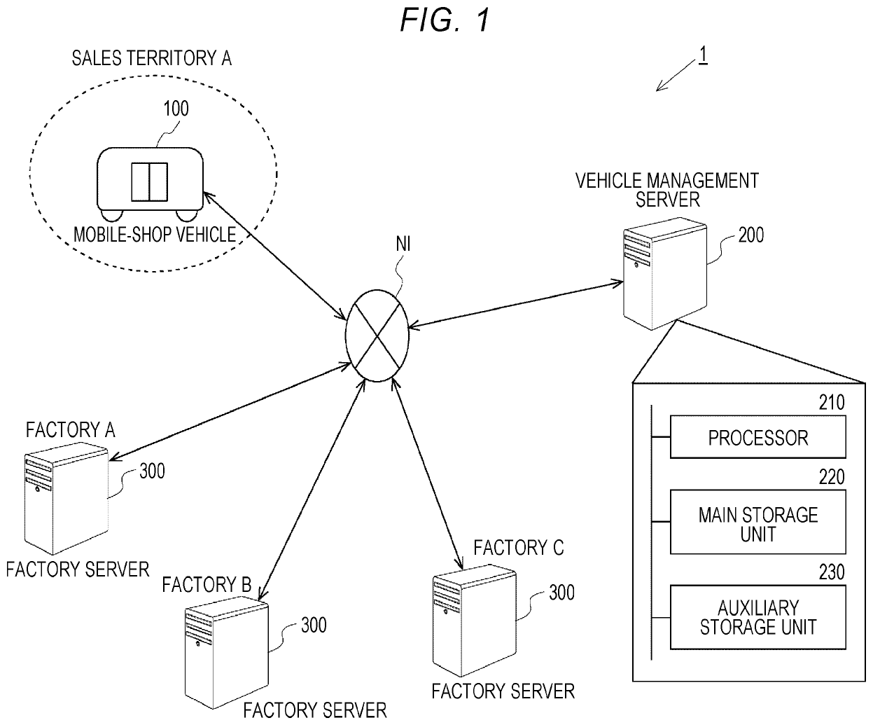

Outline of system FIG. 1 is a diagram schematically illustrating a configuration of a vehicle management system according to this embodiment. The vehicle management system 1 includes a mobile-shop vehicle (hereinafter simply referred to as a “vehicle”) 100 which can travel autonomously, a vehicle management server 200, and a plurality of factory servers 300. In the vehicle management system 1, the vehicle 100, the vehicle management server 200, and the plurality of factory servers 300 are connected to each other via a network N1. A wide area network (WAN) which is a global public communication network such as the Internet or a telephone communication network for mobile phones or the like may be employed as the network N1.

The vehicle 100 receives a traveling plan which is transmitted from the vehicle management server 200 via the network N1, and performs autonomous traveling based on the traveling plan. The vehicle 100 carries a plurality of types of commodities and sells such commodities to users in a predetermined sales territory (for example, sales territory A). At this time, the vehicle 100 can move to the predetermined sales territory by autonomous traveling for the purpose of sale of commodities.

The vehicle management server 200 includes a general computer. The computer constituting the vehicle management server 200 includes a processor 210 such as a CPU or a DSP, a main storage unit 220 such as a read only memory (ROM) or a random access memory (RAM), and an auxiliary storage unit 230 such as an EPROM, a hard disk drive (HDD), or a removable medium. Examples of the removable medium include a flash memory such as a Universal Serial Bus (USB) memory or an SD card and disc recording mediums such as a CD-ROM, a DVD disc, and a Blu-ray disc.

In the vehicle management server 200, an operating system (OS), various programs, various information tables, and the like are stored in the auxiliary storage unit 230. In the vehicle management server 200, by causing the processor 210 to load a program stored in the auxiliary storage unit 230 to the main storage unit 220 and to execute the loaded program, various functions which will be described later can be realized. Some or all functions of the vehicle management server 200 may be realized by a hardware circuit such as an ASIC or an FPGA. The vehicle management server 200 does not need to be embodied by a single physical configuration and may be embodied by a plurality of computers which cooperate with each other.

The vehicle management server 200 receives sales information which is transmitted from a vehicle 100 via the network N1 when sale of commodities is performed by the vehicle 100 in a predetermined sales territory. The sales information which is transmitted from the vehicle 100 includes information on sales conditions of commodities which are sold in the vehicle 100. The vehicle management server 200 determines a replenishment commodity which is a commodity with which the vehicle 100 is to be replenished based on the sales conditions of the commodities in the vehicle 100 in the predetermined sales territory. That is, in the vehicle management server 200, a commodity for which users' needs in a predetermined sales territory are high is selected and the selected commodity is determined as the replenishment commodity.

The factory servers 300 are servers that are installed in a plurality of factories (a factory A, a factory B, a factory C, . . . ) located within a predetermined range from the predetermined sales territory. These factories are factories which can serve as candidates for a purchase location of a commodity which is sold in the vehicle 100 when the vehicle 100 is to be replenished with the commodity. That is, in the factories, commodities which are sold in the vehicle 100 or commodities associated with the commodities which are sold in the vehicle 100 are produced. Each factory server 300 manages commodity information which is information on commodities which are produced in the corresponding factory (produced commodities).

The vehicle management server 200 receives factory information which is transmitted from the factory servers 300 via the network N1. The factory information which is transmitted from the factory servers 300 includes commodity information in the factories along with position information of the factories. The vehicle management server 200 selects a factory which becomes a purchase location of the replenishment commodity based on the factory information of the factories. At this time, the vehicle management server 200 selects a factory which produces the replenishment commodity and in which the replenishment commodity can be purchased out of the plurality of factories as a purchase location.

A purchase location of commodities which are sold in the vehicle 100 is not limited to factories. That is, a purchase location of a commodity may be a facility which is different from a factory, such as a store or a farm, depending on the commodity. In this case, similarly to the factory servers 300, a server (a facility server) for managing commodity information in a facility which can serve as a candidate for the purchase location of the commodity is connected to the network N1. The vehicle management server 200 receives facility information including position information and commodity information from the facility server.

The vehicle management server 200 creates a traveling plan of the vehicle 100 for replenishing the vehicle 100 with the replenishment commodity based on the factory information of the factory which is selected as a purchase location. Specifically, the vehicle management server 200 creates a traveling plan such that the vehicle 100 moves from a predetermined sales territory to the purchase location of the replenishment commodity, is replenished with the replenishment commodity in the purchase location, and then returns to the predetermined sales territory. The created traveling plan is transmitted from the vehicle management server 200 to the vehicle 100.

The vehicle 100 receives the traveling plan transmitted from the vehicle management server 200 via the network N1. Then, the vehicle 100 performs autonomous traveling for replenishing the vehicle 100 with the replenishment commodity based on the traveling plan received from the vehicle management server 200. Accordingly, it is possible to replenish the vehicle 100 with a commodity for which users' needs in a predetermined sales territory are high by movement of the vehicle 100. In addition, it is possible to sell the replenished commodity for which users' needs in a predetermined sales territory are high by the vehicle 100. Accordingly, it is possible to promote sales of commodities meeting users' needs.

System Configuration

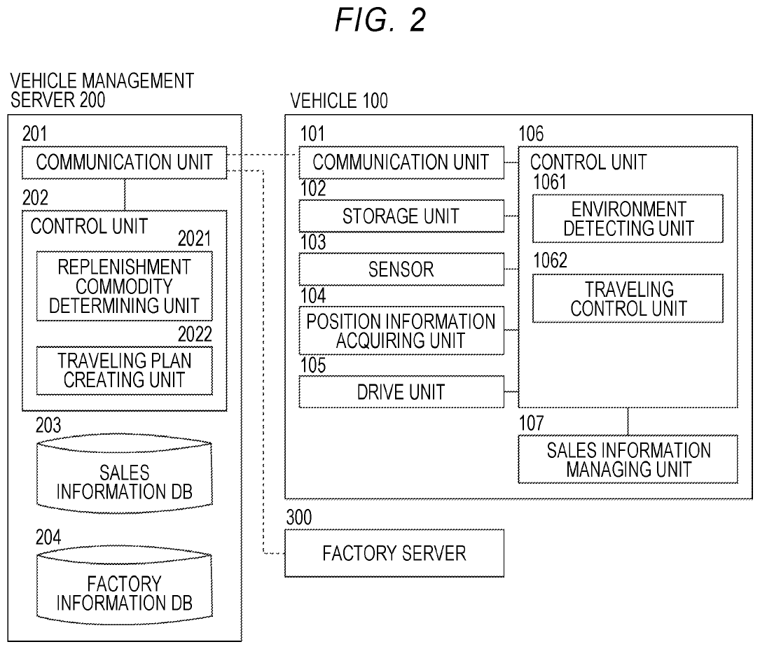

Functional configurations of a vehicle 100 and the vehicle management server 200 constituting the vehicle management system 1 according to this embodiment will be described below with reference to FIG. 2. FIG. 2 is a block diagram schematically an example of illustrating functional configurations of a vehicle 100 and the vehicle management server 200 constituting the vehicle management system 1 according to this embodiment.

Vehicle

As described above, a vehicle 100 is an autonomously traveling vehicle which travels autonomously based on a traveling plan transmitted from the vehicle management server 200. The vehicle 100 includes a communication unit 101, a storage unit 102, a sensor 103, a position information acquiring unit 104, a drive unit 105, a control unit 106, and a sales information managing unit 107. The vehicle 100 is an electric vehicle with an electric motor as a drive source. The drive source of the vehicle 100 is not limited to an electric motor, and may be an internal combustion engine. The vehicle 100 may be a hybrid vehicle including both an electric motor and an internal combustion engine as a drive source.

The communication unit 101 is a communication device that connects the vehicle 100 to the network N1. The communication unit 101 can communicate with another device including the vehicle management server 200 via the network N1 using a mobile communication service such as 3rd Generation (3G) or Long Term Evolution (LTE). The control unit 106 performs a process of transmitting sales information which is managed by the sales information managing unit 107 which will be described later to the vehicle management server 200 via the communication unit 101. The control unit 106 performs a process of receiving a traveling plan which is transmitted from the vehicle management server 200 to the vehicle 100 via the communication unit 101. The communication unit 101 may additionally include a communication device that communicates with another vehicle by vehicle-to-vehicle communication.

The storage unit 102 is a device that stores information and is constituted by a storage medium such as a magnetic disk or a flash memory. For example, map information is stored in the storage unit 102. In addition, a traveling plan received from the vehicle management server 200 is stored in the storage unit 102.

The sensor 103 is a device that senses surrounding conditions of the vehicle 100. Specifically, the sensor 103 includes a stereo camera, a laser scanner, a LiDAR, and a radar. Information on the surrounding conditions of the vehicle 100 which are acquired by the sensor 103 is transmitted to the control unit 106. The position information acquiring unit 104 is a device that acquires a current position of the vehicle 100, and specifically includes a GPS receiver. Information on the current position of the vehicle 100 which is acquired by the position information acquiring unit 104 is transmitted to the control unit 106.

The control unit 106 has a function of performing an arithmetic process for controlling the vehicle 100. The control unit 106 is constituted by, for example, a microcomputer. The control unit 106 includes an environment detecting unit 1061, a traveling control unit 1062, and a traveling plan creating unit 1063 as functional modules. The functional modules may be realized by causing a processor such as a CPU to execute a program stored in a storage unit such as a ROM of the control unit 106. Some or all of the functions may be realized by a hardware circuit such as an ASIC or an FPGA.

The environment detecting unit 1061 detects a surrounding environment of the vehicle 100 based on information acquired by the sensor 103. For example, the environment detecting unit 1061 detects an object (including a person or an animal) such as another vehicle near the host vehicle. The environment detecting unit 1061 detects various objects which are required for autonomous traveling of the vehicle 100 such as the number of lanes or the position of each road, a structure of each road, and road signs. The environment detecting unit 1061 may track the detected object. In this case, a relative speed of the object may be calculated, for example, from differences between coordinates of the object which have been previously detected and current coordinates of the object.

The traveling control unit 1062 controls traveling of the vehicle 100 based on the traveling plan stored in the storage unit 102, the position information of the vehicle 100 acquired by the position information acquiring unit 104, and data of the surrounding environment detected by the environment detecting unit 1061. For example, the traveling control unit 1062 causes the vehicle 100 to travel on a traveling route included in the traveling plan in accordance with a traveling schedule included in the traveling plan. When an object with a possibility of collision with the vehicle 100 is detected by the environment detecting unit 1061, the traveling control unit 1062 performs collision avoidance control for causing the vehicle 100 to travel to avoid collision with the object. Any known method can be employed as a method of causing the vehicle 100 to travel autonomously as described.

The drive unit 105 includes a motor serving as a drive source and mechanisms for causing the vehicle 100 to travel (for example, an inverter, a brake, and a steering mechanism). The drive unit 105 causes the vehicle 100 to travel based on a command which is generated to control traveling of the vehicle 100 by the traveling control unit 1062. Accordingly, autonomous traveling of the vehicle 100 is realized.

The sales information managing unit 107 is a device that manages sales conditions of a plurality of types of commodities in the vehicle 100. The sales information managing unit 107 is a computer which is integrated with the control unit 106 or is separate from the control unit 106. For example, by attaching radio frequency identifier (RFID) tags to commodities which are sold in the vehicle 100 and installing an RFID reader terminal that reads information from the RFID tags in the vehicle 100, the numbers of commodities which are sold to users or the like can be managed by the sales information managing unit 107.

The vehicle 100 is not necessarily a vehicle that travels without an occupant. For example, a person such as a service staff member who introduces commodities sold in the vehicle 100 to users or a security personnel who takes charge of security of the vehicle 100 may be in the vehicle 100. The vehicle 100 may not be necessarily a vehicle that normally travels autonomously. For example, the vehicle 100 may be a vehicle which can switch between an automated driving mode and a manual driving mode.

Management Server

The vehicle management server 200 includes a communication unit 201, a control unit 202, a sales information database (a sales information DB) 203, and a factory information database (a factory information DB) 204. The communication unit 201 is a communication device that connects the vehicle management server 200 to the network N1. The communication unit 201 includes, for example, a local area network (LAN) interface board and a radio communication circuit for radio communication. The control unit 202 performs a process of transmitting a traveling plan to each vehicle 100 via the communication unit 201.

The control unit 202 performs a process of receiving sales information which is transmitted from the vehicles 100 via the communication unit 201 and storing the received sales information in the sales information DB 203. The control unit 202 performs a process of receiving factory information which is transmitted from the factory servers 300 via the communication unit 201 and storing the received factory information in the factory information DB 204. The sales information DB 203 and the factory information DB 204 are constructed in the auxiliary storage unit 230 of the vehicle management server 200 by causing the processor 210 of the vehicle management server 200 to execute a program of a database management system.

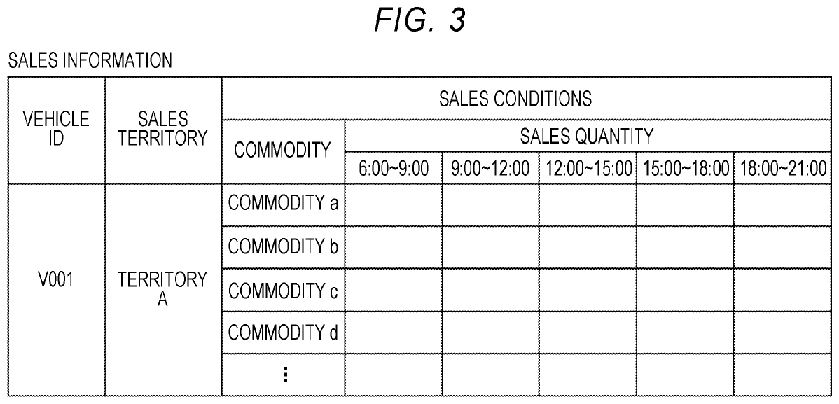

FIG. 3 is a diagram illustrating an example of a configuration of a sales information table which is stored in the sales information DB 203. As illustrated in FIG. 3, the sales information table includes a vehicle ID field, a sales territory field, and a sales conditions field. A vehicle ID which is identification information for identifying a vehicle 100 is input to the vehicle ID field. A predetermined sales territory in which commodities are sold to users by the vehicle 100 is input to the sales territory field. Commodity names (commodity a, commodity b, commodity c, commodity d, . . . ) of commodities which are sold by the vehicle 100 and sales conditions of the commodities are input to the sales conditions field. Specifically, the number of pieces of each commodity sold in each of time periods is input to the sales conditions field. In the example illustrated in FIG. 3, the time periods for inputting the number of pieces of each commodity which have been sold to the sales conditions field are divided into “6:00-9:00,” “9:00-12:00,” “12:00-15:00,” “15:00-18:00,” and “18:00-21:00.” Sales information which is transmitted from the vehicle 100 to the vehicle management server 200 includes information which is input to the fields of the sales information table illustrated in FIG. 3.

At a predetermined time during when commodities are sold in a predetermined sales territory (for example, a time period in which the numbers of commodities sold are input to the sales conditions field illustrated in FIG. 3), sales information may be transmitted from the vehicle 100 to the vehicle management server 200. Every sales day in which commodities are sold in a predetermined sales territory, sales information may be transmitted from the vehicle 100 to the vehicle management server 200.

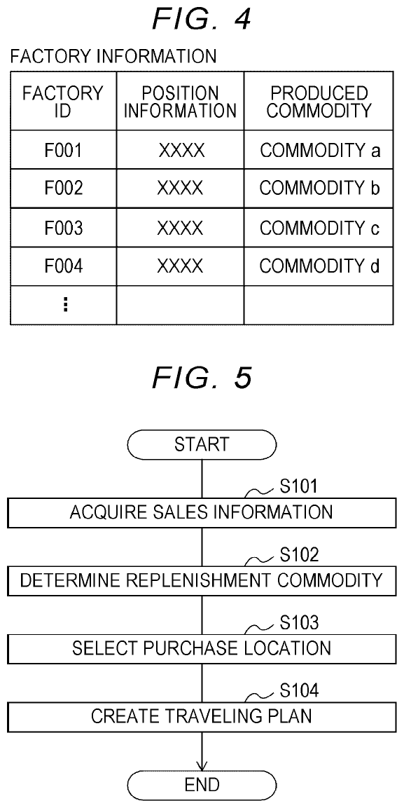

FIG. 4 is a diagram illustrating an example of a configuration of a factory information table which is stored in the factory information DB 204. As illustrated in FIG. 4, the factory information table includes a factory ID field, a position information field, and a produced commodity field. A factory ID which is identification information for identifying a factory serving as a transmission source of factory information is input to the factory ID field. Position information of a factory serving as a transmission source of factory information is input to the position information field. Commodity names (commodity a, commodity b, commodity c, commodity d, . . . ) of commodities which are produced in the factory serving as a transmission source of factory information are input to the produced commodity field.

The control unit 202 has a function of performing arithmetic processing for controlling the vehicle management server 200. The control unit 202 can be realized by the processor 210. The control unit 202 includes a replenishment commodity determining unit 2021 and a traveling plan creating unit 2022 as functional modules. The replenishment commodity determining unit 2021 performs a replenishment commodity determining process of determining a replenishment commodity with which a vehicle 100 selling commodities to users in a predetermined sales territory is to be replenished. The traveling plan creating unit 2022 performs a traveling plan creating process of creating a traveling plan of a vehicle 100 for replenishing the vehicle 100 with a replenishment commodity.

Replenishment Commodity Determining Process and Traveling Plan Creating Process

The replenishment commodity determining process which is performed by the replenishment commodity determining unit 2021 and the traveling plan creating process which is performed by the traveling plan creating unit 2022 will be described below with reference to FIG. 5. FIG. 5 is a flowchart illustrating a flow of the replenishment commodity determining process and the traveling plan creating process. In the flow illustrated in FIG. 5, the processes of S101 and S102 correspond to the replenishment commodity determining process and the processes of S103 and S104 correspond to the traveling plan creating process.

In this flow, first, in S101, sales information which is acquired from the vehicle 100 and stored in the sales information DB 203 is acquired. Then, in S102, a replenishment commodity with which the vehicle 100 is to be replenished is determined based on sales conditions of the commodities in a predetermined sales territory included in the sales information acquired in S101. At this time, the replenishment commodity determining unit 2021 determines a commodity for which users' needs in the predetermined sales territory are determined to be high as a replenishment commodity. For example, the replenishment commodity determining unit 2021 may determine a commodity of which the total number sold in the predetermined sales territory is the largest out of a plurality of commodities sold in the vehicle 100 as a replenishment commodity. The replenishment commodity determining unit 2021 may determine a commodity which is not currently sold in the vehicle 100 but for which users' needs in the predetermined sales territory are predicted to be high as a replenishment commodity from sales results of the commodities in the vehicle 100 in the predetermined sales territory.

Then, in S103, a factory which becomes a purchase location of the replenishment commodity determined in S102 is selected out of a plurality of factories of which factory information is stored in the factory information DB 204. At this time, a factory in which the replenishment commodity is included in the produced commodities input to the produced commodity field of the factory information DB 204 is selected as the purchase location.

The vehicle management server 200 may receive relevant information such as inventory quantities or production dates and times of the produced commodities in addition to the commodity names of the produced commodities as commodity information from the factory servers 300 of the factories. In this case, relevant information such as inventory quantities or production dates and times of the produced commodities is also stored as factory information of the factories in the factory information DB 204. When there is a plurality of factories of which the produced commodities include the replenishment commodity, the traveling plan creating unit 2022 may select the factory of the purchase location based on the relevant information of the produced commodities in the factories.

Then, in S104, a traveling plan is created based on position information of the factory which is included in the factory information of the factory of the purchase location selected in S103. At this time, the traveling plan creating unit 2022 creates a traveling plan such that the vehicle 100 first travels on a traveling route with a predetermined sales territory as a departure position and the factory of the purchase location as a destination and then the vehicle 100 replenished with the replenishment commodity travels on a traveling route with the factory of the purchase location as a departure position and the predetermined sales territory as a destination. The traveling plan includes a traveling schedule indicating a scheduled departure time from a departure position and a scheduled arrival time at a destination in addition to the traveling routes.

When the traveling plan of the vehicle 100 is created as described above, the control unit 202 transmits the traveling plan to the vehicle 100. Thereafter, the vehicle 100 having received the traveling plan travels based on the traveling plan.

In the above-mentioned embodiment, the vehicle management server 200 selects a purchase location of a replenishment commodity based on the factory information stored in the factory information DB 204 which is provided in the vehicle management server 200. Here, the vehicle management server 200 does not necessarily include the factory information DB 204. For example, the vehicle management server 200 may acquire factory information on the factory which is a purchase location of a replenishment commodity from an external device via the network after the replenishment commodity has been determined. In this case, the vehicle management server 200 transmits a commodity ID identifying the replenishment commodity to the external device. Then, the external device retrieves a factory that produces the replenishment commodity based on the received commodity ID, and transmits factory information of the retrieved factory to the vehicle management server 200.

### Modified Example

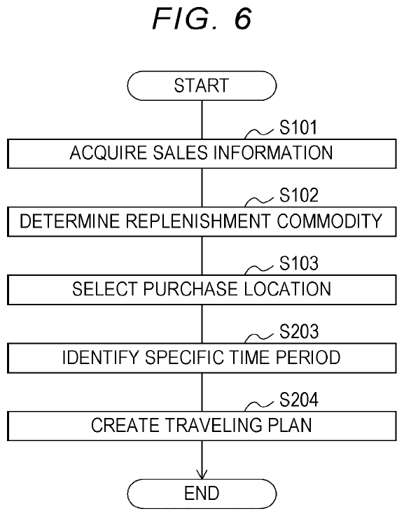

A traveling plan creating process according to a modified example of the embodiment will be described below with reference to FIG. 6. FIG. 6 is a flowchart illustrating a flow of the replenishment commodity determining process and the traveling plan creating process according to this modified example. In the flow illustrated in FIG. 6, the processes of S101 and S102 correspond to the replenishment commodity determining process, and processes associated with these steps are the same as in the replenishment commodity determining process in the flow illustrated in FIG. 5. In the flow illustrated in FIG. 6, the processes of S103, S203, and S204 correspond to the traveling plan creating process. Processes associated with S103 out of these steps are the same as in the traveling plan creating process in the flow illustrated in FIG. 5.

In the traveling plan creating process according to this modified example, in S203, a specific time period for the replenishment commodity determined in S102 is identified. Here, the specific time period is a time period in which a sales quantity of the replenishment commodity in the predetermined sales territory is predicted to be greater than that in other time periods. As described above, a sales quantity for each commodity in the vehicle 100 for each time period in the predetermined sales territory is input to the sales information DB 203 of the vehicle management server 200. Accordingly, it is possible to ascertain a change in sales quantity for each commodity for each time period in a predetermined sales territory. Therefore, in S203, the traveling plan creating unit 2022 predicts a specific time period for the replenishment commodity based on the change in sales quantity for each time period which can be ascertained from information input to the sales information DB 203. For example, a time period in which the sales quantity of the commodity determined as the replenishment commodity is the largest may be identified as the specific time period.

When the specific time period for the replenishment commodity is predicted in S203, a traveling plan including a traveling schedule in consideration of the specific time period is then created in S204. At this time, a traveling route of the vehicle 100 included in the traveling plan is the same as a traveling route included in the traveling plan which is created in the traveling plan creating process in the flow illustrated in FIG. 5. That is, in S204, first, a traveling plan is created such that the vehicle 100 travels on a traveling route with a predetermined sales territory as a departure position and the factory of the purchase location as a destination and then the vehicle 100 replenished with the replenishment commodity travels on a traveling route with the factory of the purchase location as a departure position and the predetermined sales territory as a destination.

Here, in S204, the traveling plan creating unit 2022 creates a traveling plan including a traveling schedule in which the vehicle 100 replenished with the replenishment commodity in the factory of the purchase location returns to the predetermined sales territory before the specific time period predicted in S203. That is, the traveling schedule included in the traveling plan created in S204 is a schedule in which the vehicle 100 departs from the predetermined sales territory to the factory of the purchase location for the purpose of replenishment with the replenishment commodity before the specific time period and the vehicle 100 returns from the factory of the purchase location to the predetermined sales territory before the specific time period.

By causing the vehicle 100 to travel autonomously based on the traveling plan including the above-mentioned traveling schedule, the vehicle 100 can sell commodities in the specific time period in the predetermined sales territory in a state in which the commodity for which users' needs in the predetermined sales territory are high is better maintained in an inventory. It is possible to prevent occurrence of a case in which the vehicle 100 moves from the predetermined sales territory in the specific time period in which the sales quantity of the replenishment commodity is predicted to increase for the purpose of replenishment with the replenishment commodity. Accordingly, it is possible to promote sales of commodities meeting users' needs in a predetermined sales territory.

In the vehicle management system 1 according to the embodiment, the vehicle management server 200 creates a traveling plan of a vehicle 100 and transmits the traveling plan to the vehicle 100 via the network N1. On the other hand, a configuration in which the vehicle 100 creates a traveling plan may be employed. That is, an information processing device having a function corresponding to the vehicle management server 200 in the embodiment may be provided in the vehicle 100. In this case, the vehicle 100 can independently perform determination of a replenishment commodity, selection of a purchase location, and creation of a traveling plan and then travel autonomously based on the traveling plan.

### Other Embodiments

The above-mentioned embodiment is only an example, and the disclosure can be appropriately modified in various forms without departing from the gist thereof. The processes or units which have been described above in the present disclosure can be freely combined and embodied as long as no technical contradictions arise.

A process which has been described to be performed by a single device may be distributed to and performed by a plurality of devices. Alternatively, processes which have been described to be performed by different devices may be performed by a single device. In a computer system, by what hardware configuration (server configuration) each function is to be embodied can be flexibly changed.

The disclosure can also be embodied by supplying a computer program storing the functions described above in the above-mentioned embodiment to a computer and causing one or more processors of the computer to read and execute the computer program. Such a computer program may be provided to the computer via a non-transitory computer-readable storage medium which can access a system bus of the computer or may be provided to the computer via a network. Examples of the non-transitory computer-readable storage medium include an arbitrary type of disk such as a magnetic disk (such as a Floppy (registered trademark) disk or a hard disk drive (HDD)) or an optical disc (such as a CD-ROM, a DVD disc, or a blue-ray disc), a read only memory (ROM), a random access memory (RAM), an EPROM, an EEPROM, a magnetic card, a flash memory, an optical card, and an arbitrary type of medium which is suitable for storing electronic commands.

What is claimed is:

1. An information processing device that manages traveling of a mobile-shop vehicle which sells commodities to users and which is able to travel autonomously, the information processing device comprising a control unit configured to perform:
determining a replenishment commodity which is a commodity with which the mobile-shop vehicle is to be replenished based on sales conditions of a plurality of types of commodities when the commodities are sold by the mobile-shop vehicle in a predetermined sales territory; and
creating a traveling plan for the mobile-shop vehicle based on purchase location information on a purchase location in which the replenishment commodity is to be purchased and which includes at least position information of the purchase location.

2. The information processing device according to claim 1, wherein the control unit is configured to create the traveling plan such that the mobile-shop vehicle moves from the predetermined sales territory to the purchase location, is replenished with the replenishment commodity in the purchase location, and then returns to the predetermined sales territory.

3. The information processing device according to claim 2, wherein the control unit is configured to additionally perform:
identifying a specific time period which is a time period in which a sales quantity of the replenishment commodity in the predetermined sales territory is predicted to be greater than those in other time periods based on a sales condition of the replenishment commodity in the predetermined sales territory; and
creating the traveling plan such that the mobile-shop vehicle having been replenished with the replenishment commodity in the purchase location returns to the predetermined sales territory before the specific time period.

4. A mobile-shop vehicle that sells commodities to users and that is able to travel autonomously, the mobile-shop vehicle comprising an information processing device configured to perform:
determining a replenishment commodity which is a commodity with which the mobile-shop vehicle is to be replenished based on sales conditions of a plurality of types of commodities when the commodities are sold by the mobile-shop vehicle in a predetermined sales territory; and
creating a traveling plan for the mobile-shop vehicle based on purchase location information on a purchase location in which the replenishment commodity is to be purchased and which includes at least position information of the purchase location.

5. An information processing method of managing traveling of a mobile-shop vehicle which sells commodities to users and which is able to travel autonomously, the information processing method being performed by a computer, the information processing method comprising:
determining a replenishment commodity which is a commodity with which the mobile-shop vehicle is to be replenished based on sales conditions of a plurality of types of commodities when the commodities are sold by the mobile-shop vehicle in a predetermined sales territory; and
creating a traveling plan for the mobile-shop vehicle based on purchase location information on a purchase location in which the replenishment commodity is to be purchased and which includes at least position information of the purchase location.

6. A program causing a computer to perform an information processing method of managing traveling of a mobile-shop vehicle which sells commodities to users and which is able to travel autonomously, the information processing method comprising:
determining a replenishment commodity which is a commodity with which the mobile-shop vehicle is to be replenished based on sales conditions of a plurality of types of commodities when the commodities are sold by the mobile-shop vehicle in a predetermined sales territory; and
creating a traveling plan for the mobile-shop vehicle based on purchase location information on a purchase location in which the replenishment commodity is to be purchased and which includes at least position information of the purchase location.
